(19) United States
(12) Patent Application Publication
(10) Pub. No.: US 2026/0154990 A1
(43) Pub. Date: Jun. 4, 2026

(54) ELECTRONIC APPARATUS FOR OBTAINING A TARGET MODALITY BASED ON AT LEAST ONE MODALITY AND CONTROL METHOD THEREOF

(71) Applicant: SAMSUNG ELECTRONICS CO., LTD., Suwon-si (KR)

(72) Inventors: Dmytro PROGONOV, Kyiv (UA); Oleksandra SOKOL, Kyiv (UA); Kostiantyn MELNIK, Kyiv (KR); Andrii ASTRAKHANTSEV, Kyiv (UA)

(21) Appl. No.: 19/457,646

(22) Filed: Jan. 23, 2026

Related U.S. Application Data
(63) Continuation of application No. PCT/KR2025/018316, filed on Nov. 7, 2025.

(30) Foreign Application Priority Data
Dec. 2, 2024 (KR) 10-2024-0176796

(51) Int. Cl. G06V 40/70; G06V 10/82

(52) U.S. Cl. CPC G06V 40/70; G06V 10/82

(57) ABSTRACT

An electronic apparatus includes: a memory storing cross-modality dependency information including information on a correlation between modalities, a neural network model, and instructions, and at least one processor including processing circuitry, wherein at least one processor, individually or collectively, is configured to execute the instructions and to cause the electronic apparatus to: obtain a first modality of a first type from among a plurality of modality types, identify information corresponding to the first type and a second type from among the cross-modality dependency information based on context, and obtain a second modality of the second type by inputting the first modality and the identified information in the neural network model.

### CROSS-REFERENCE TO RELATED APPLICATIONS

This application is a continuation of International Application No. PCT/KR2025/018316 designating the United States, filed on Nov. 7, 2025, in the Korean Intellectual Property Receiving Office and claiming priority to Korean Patent Application No. 10-2024-0176796, filed on Dec. 2, 2024, in the Korean Intellectual Property Office, the disclosures of each of which are incorporated by reference herein in their entireties.

### BACKGROUND

### Field

The disclosure relates to an electronic apparatus and a control method thereof, and for example, to an electronic apparatus for obtaining a target modality based on at least one modality and a control method thereof.

### Description of Related Art

With developments in electronic technology, electronic apparatuses providing various functions are being developed. Specifically, an electronic apparatus may collect various biometric information of a user. For example, the electronic apparatus may collect various biometric information such as face, voice, fingerprints, heart rate, bioacoustic signals, and the like. The biometric information described above may vary according to a physical/emotional state of the user, and may be referred to as a modality.

However, conventional electronic apparatuses process each modality independently leading to an increase in operation overhead in apparatuses with limited resources.

In addition, conventional electronic apparatuses essentially require a camera due to frequently use of mainly biometric information such as the face, and in case there is no camera, functions associated with biometric information may be limited.

### SUMMARY

According to an example embodiment of the disclosure, an electronic apparatus includes: a memory storing cross-modality dependency information including information on a correlation between modalities, a neural network model, and instructions, and at least one processor, comprising processing circuitry, wherein at least one processor, individually and/or collectively, is configured to execute the instructions, and to cause the electronic apparatus to: obtain a first modality of a first type from among a plurality of modality types, identify information corresponding to the first type and a second type from among the cross-modality dependency information based on context, and obtain a second modality of the second type by inputting the first modality and the identified information in the neural network model.

At least one processor, individually or collectively, may be configured to cause the electronic apparatus to: obtain the first modality of the first type and a third modality of the second type from among the plurality of modality types, identify, based on a portion of the third modality being identified as corrupted or identified as requiring restoration, information corresponding to the first type and the second type from among the cross-modality dependency information, obtain the second modality of the second type corresponding to the third modality by inputting the first modality and the identified information in the neural network model, and restore a portion of the third modality based on the second modality.

At least one processor, individually or collectively, may be configured to cause the electronic apparatus to identify information corresponding to the first type and the second type from among the cross-modality dependency information based on an application in execution in the electronic apparatus.

A communication interface comprising communication circuitry and a display may be further included, wherein at least one processor, individually or collectively, may be configured to cause the electronic apparatus to: obtain, based on a video call application being executed, the first modality of a voice type from among the plurality of modality types from another electronic apparatus through the communication interface, identify information corresponding to the voice type and a video type from among the cross-modality dependency information based on the video call application, obtain the second modality of the video type by inputting the first modality and the identified information in the neural network model, and display a screen corresponding to the second modality through the display.

At least one processor, individually or collectively, may be configured to cause the electronic apparatus to update the second modality based on a state of a communication channel with the another electronic apparatus, and display a screen corresponding to the updated second modality through the display.

A microphone and a communication interface comprising communication circuitry may be further included, and at least one processor, individually or collectively, may be configured to cause the electronic apparatus to: obtain, based on a video call application being executed, the first modality of a voice type from among the plurality of modality types through the microphone, identify information corresponding to the voice type and a video type from among the cross-modality dependency information based on the video call application, obtain second modality of the video type by inputting the first modality and the identified information in the neural network model, and control the communication interface to transmit the second modality to the another electronic apparatus.

At least one processor, individually or collectively, may be configured to cause the electronic apparatus to: obtain the first modality of the first type and a third modality of a third type from among the plurality of modality types, identify information corresponding to the first type and the third type from among the cross-modality dependency information, and verify the other one from among the first modality and the third modality based on information obtained by inputting one from among the first modality and the third modality and the identified information in the neural network model.

At least one processor, individually or collectively, may be configured to cause the electronic apparatus to update the second modality based on a state of health of a user corresponding to the first modality.

At least one processor, individually or collectively, may be configured to cause the electronic apparatus to: obtain the first modality of the first type from among the plurality of modality types, encode the first modality, identify information corresponding to the first type and the second type from among the cross-modality dependency information based on the context, obtain output data by inputting the encoded first modality and the identified information in the neural network model, and obtain the second modality by decoding the output data.

The cross-modality dependency information may be obtained based on sample modalities of at least two types from among the plurality of modality types.

According to an example embodiment of the disclosure, a method of operating an electronic apparatus includes: obtaining a first modality of a first type from among a plurality of modality types, identifying information corresponding to the first type and a second type from among cross-modality dependency information which includes information on a correlation between modalities based on context, and obtaining a second modality of the second type by inputting the first modality and the identified information in a neural network model.

The obtaining a first modality may include obtaining the first modality of the first type and a third modality of the second type from among the plurality of modality types, the identifying may include identifying, based on a portion of the third modality being identified as corrupted or identified as requiring restoration, information corresponding to the first type and the second type from among the cross-modality dependency information, and the obtaining a second modality may include obtaining the second modality of the second type corresponding to the third modality by inputting the first modality and the identified information in the neural network model, and the control method may further include restoring a portion of the third modality based on the second modality.

The identifying may include identifying information corresponding to the first type and the second type from among the cross-modality dependency information based on an application in execution in the electronic apparatus.

The obtaining a first modality may include obtaining, based on a video call application being executed, the first modality of a voice type from among the plurality of modality types from another electronic apparatus, the identifying may include identifying information corresponding to the voice type and a video type from among the cross-modality dependency information based on the video call application, and the obtaining a second modality may include obtaining a second modality of the video type by inputting the first modality and the identified information in the neural network model, and the control method may further include displaying a screen corresponding to the second modality.

Updating the second modality based on a state of a communication channel with the another electronic apparatus may be further included, and the displaying may include displaying a screen corresponding to the updated second modality.

The obtaining a first modality may include obtaining, based on a video call application being executed, the first modality of a voice type from among the plurality of modality types through a microphone included in the electronic apparatus, the identifying may include identifying information corresponding to the voice type and a video type from among the cross-modality dependency information based on the video call application, the obtaining a second modality may include obtaining second modality of the video type by inputting the first modality and the identified information in the neural network model, and the control method may further include transmitting the second modality to the another electronic apparatus.

The obtaining a first modality may include obtaining the first modality of the first type and a third modality of a third type from among the plurality of modality types, and the control method may further include identifying information corresponding to the first type and the third type from among the cross-modality dependency information, and verifying the other one from among the first modality and the third modality based on information obtained by inputting one from among the first modality and the third modality and the identified information in the neural network model.

Updating the second modality based on a state of health of a user corresponding to the first modality may be further included.

The control method may further include encoding the first modality, and the obtaining a second modality may include obtaining output data by inputting the encoded first modality and the identified information in the neural network model, and obtaining the second modality by decoding the output data.

The cross-modality dependency information may be obtained based on sample modalities of at least two types from among the plurality of modality types.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic apparatus according to various embodiments;

FIG. 2 is a block diagram illustrating an example configuration of an electronic apparatus according to various embodiments;

FIG. 3 is a diagram illustrating an example neural network model according to various embodiments;

FIG. 4 is a diagram illustrating an example operation according to an incomplete modality according to various embodiments;

FIG. 5 is a diagram illustrating an example method for processing modality according to various embodiments;

FIG. 6 is a diagram illustrating cross-modality dependency information and a training method of a neural network model according to various embodiments;

FIG. 7 is a diagram illustrating an example neural network operation according to various embodiments;

FIG. 8 is a diagram illustrating an example operation due to a difference in specification between apparatuses according to various embodiments;

FIG. 9 is a diagram illustrating an example method for providing an emoji according to various embodiments;

FIG. 10 and FIG. 11 are diagrams illustrating an example operation according to a transmission error according to various embodiments;

FIG. 12 is a diagram illustrating an example verification operation between modalities according to various embodiments;

FIG. 13 is a diagram illustrating an effect according to various embodiments; and

FIG. 14 is a flowchart illustrating an example method of operating an electronic apparatus according to various embodiments.

### DETAILED DESCRIPTION

The various example embodiments of the present disclosure may be diversely modified. Accordingly, various example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions may not be described in detail if they would obscure the disclosure with unnecessary detail.

An aspect of the disclosure lies in providing an electronic apparatus which addresses nonlinearity and complexity between modalities, and obtains a target modality based on at least one modality and a control method thereof.

The disclosure will be described in greater detail below with reference to the accompanying drawings.

Terms used in describing various embodiments of the disclosure are general terms selected that are currently widely used considering their function herein. However, the terms may change depending on intention, legal or technical interpretation, emergence of new technologies, and the like of those skilled in the related art. Further, in certain cases, there may be terms that are arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the relevant element.

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

In the disclosure, the term “user” may refer to a person using an electronic apparatus or an apparatus (e.g., artificial intelligence electronic apparatus) using the electronic apparatus.

Various embodiments of the disclosure will be described in greater detail below with reference to the accompanied drawings.

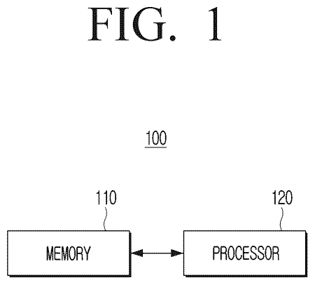

FIG. 1 is a block diagram illustrating an example configuration of an electronic apparatus 100 according to various embodiments.

The electronic apparatus 100 may process modality. For example, the electronic apparatus 100 may include an apparatus such as, for example, and without limitation, a main body of a computer, a set top box (STB), a server, an artificial intelligence (AI) speaker, a television (TV), a desktop personal computer (PC), a notebook, a smartphone, a tablet PC, smart glasses, a smart watch, and the like. However, the disclosure is not limited thereto, and the electronic apparatus 100 may be any apparatus so long as it is an apparatus capable of processing modality.

Referring to FIG. 1, the electronic apparatus 100 may include a memory 110 and a processor (e.g., including processing circuitry) 120.

The memory 110 may refer to hardware that stores information such as data for the processor 120 and the like to access in an electric or magnetic form. To this end, the memory 110 may be implemented as at least one hardware from among a non-volatile memory, a volatile memory, a flash memory, a hard disk drive (HDD) or a solid state drive (SSD), a random access memory, a read only memory, and the like.

In the memory 110, at least one instruction required in an operation of the electronic apparatus 100 or the processor 120 may be stored. The instruction may be a code unit that instructs an operation of the electronic apparatus 100 or the processor 120, and may be prepared in a machine language which is a language that can be understood by a computer. Alternatively, the memory 110 may be stored with a plurality of instructions that perform a specific work of the electronic apparatus 100 or the processor 120 as an instruction set.

The memory 110 may be stored with data which is information in a bit or byte unit that can represent a character, a number, an image, and the like. For example, the memory 110 may be stored with cross-modality dependency information, a neural network model, and the like. The cross-modality dependency information may include information on a correlation between modalities. For example, the cross-modality dependency information may be obtained based on sample modalities of at least two types from among a plurality of modality types. In an example, the cross-modality dependency information may include information about a correlation between a face of a user and a voice of the user. The cross-modality dependency information may further include information about the correlation between the face of the user and an electrocardiogram (ECG) of the user. However, the disclosure is not limited thereto, and the cross-modality dependency information may further include information about a correlation between any various biometric information. In addition, the cross-modality dependency information may further include information about a correlation between modalities of not just two types, but also a number greater than or equal to that thereof. The neural network model may include a model trained to output a new modality. For example, the neural network model may be a model trained to output a modality of a target type based on information corresponding to a type of a first modality and a target type from among the first modality and the cross-modality dependency information being input.

The memory 110 may be accessed by the processor 120 and reading, writing, modifying, deleting, updating, and the like of the instruction, the instruction set, or data may be performed by the processor 120.

The processor 120 may include various processing circuitry and control an overall operation of the electronic apparatus 100. For example, the processor 120 may control the overall operation of the electronic apparatus 100 by being connected with each configuration of the electronic apparatus 100. For example, the processor 120 may control an operation of the electronic apparatus 100 by being connected with configurations such as the memory 110.

The 120 may, for example, include one or more processors from among a central processing unit (CPU), a graphics processing unit (GPU), an accelerated processing unit (APU), a many integrated core (MIC), a neural processing unit (NPU), a hardware accelerator, or a machine learning accelerator. The one or more processors 120 may control one or a random combination from among other elements of the electronic apparatus 100, and perform an operation associated with communication or data processing. The one or more processors 120 may execute one or more programs or instructions stored in the memory. For example, the one or more processors 120 may perform, by executing one or more instructions stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 120 may be implemented as a single core processor that includes one core, or implemented as one or more multicore processors that include a plurality of cores (e.g., a homogeneous multicore or a heterogeneous multicore). If the one or more processors 120 are implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In an embodiment of the disclosure, the one or more processors 120 may refer, for example, to a system on chip (SoC), the single core processor, or the multicore processors in which the one or more processors and other electronic components are integrated, or a core included in the single core processor or the multicore processors, and the core herein may be implemented as the CPU, the GPU, the APU, the MIC, the NPU, the hardware accelerator, the machine learning accelerator, or the like, but the disclosure is not limited thereto. However, for convenience of description, an operation of the electronic apparatus 100 will be described below using the expression ‘processor 120.’

The processor 120 may obtain the first modality of a first type from among the plurality of modality types. For example, the processor 120 may obtain the first modality of the first type through a camera, a microphone, a sensor, and the like included in the electronic apparatus 100. The processor 120 may receive the first modality of the first type from another electronic apparatus. Modality may refer, for example, to various biometric information such as, for example, and without limitation, the face, the voice, fingerprints, heart rate, a bioacoustic signal, and the like of the user. If the processor 120 obtains the first modality of the first type through the camera, the microphone, the sensor, and the like included in the electronic apparatus 100, the first modality associated with the user of the electronic apparatus 100 may be obtained. If the processor 120 receives the first modality of the first type from another electronic apparatus, the first modality associated with another user of the another electronic apparatus may be obtained.

The processor 120 may identify information corresponding to the first type and a second type from among the cross-modality dependency information stored in the memory 110 based on context. For example, the cross-modality dependency information may include information on the correlation between the face of the user and the voice of the user, information on a correlation between the face of the user and the electrocardiogram of the user, information on a correlation of the face of the user and a minute motion of the user, information on a correlation of a walk of the user and the minute motion of the user, information on a correlation of a fingerprint of the user and a venous structure of a palm of the user, and the like. The processor 120 may identify, if, for example, the voice of the user is obtained as the first modality of the first type, and the face of the user is identified as the second type, information about the correlation between the face of the user and the voice of the user from among the cross-modality dependency information.

However, the disclosure is not limited thereto, and the processor 120 may identify information corresponding to the first type and the second type from among the cross-modality dependency information based on an application currently in execution. The processor 120 may identify information corresponding to the first type and the second type from among the cross-modality dependency information based on a position of the user. The processor 120 may identify the second type from among the plurality of modality types based on the first type, and identify information corresponding to the first type and the second type from among the cross-modality dependency information.

The processor 120 may obtain a second modality of the second type by inputting the first modality and the identified information in the neural network model. In the above-described example, the processor 120 may obtain the face of the user as the second modality of the second type by inputting the voice of the user which is the first modality of the first type and information about the correlation between the face of the user and the voice of the user from among the cross-modality dependency information in the neural network model.

The processor 120 may further use, not only the first modality, but also the cross-modality dependency information to obtain the second modality and thereby, making it possible to reduce a load generated by nonlinearity and complexity between the modalities and obtain the modality in even an on-device form.

The processor 120 may obtain the first modality of the first type and a third modality of the second type from among the plurality of modality types, and identify, based on a portion of the third modality being identified as corrupted or identified as requiring restoration, information corresponding to the first type and the second type from among the cross-modality dependency information, obtain the second modality of the second type corresponding to the third modality by inputting the first modality and the identified information in the neural network model, and restore a portion of the third modality based on the second modality.

For example, if the user is in a video call with another user, the processor 120 may obtain the first modality of a video type and the third modality of a voice type from another electronic apparatus used by the another user. The processor 120 may identify corruption of the received data or identify as requiring restoration while providing a video call function. For example, the processor 120 may identify corruption in a portion of the third modality of the voice type or identify as requiring restoration. In this case, the processor 120 may identify information about a correlation between the video and the voice from among the cross-modality dependency information, and obtain the second modality of the voice type corresponding to the third modality by inputting the first modality and the identified information in the neural network model. Here, the second modality may be information which was restored as the voice type using the cross-modality dependency information from the first modality of the video type, and the processor 120 may restore a portion of the third modality based on the second modality. That is, the processor 120 may maintain the remaining of the third modality which was not corrupted, and restore only the portion of the third modality which was corrupted based on the second modality.

The processor 120 may identify, based on a reading of the portion of the third modality not being possible, the portion of the third modality as being corrupt. Alternatively, the processor 120 may identify that the portion of the third modality requires restoration based on an error detection method such as an error correction code. However, the disclosure is not limited thereto, and the processor 120 may identify as the portion of the third modality being corrupted with any various method or identify as requiring restoration.

In the above, the processor 120 has been described as obtaining the first modality and the third modality, but is not limited thereto. For example, the processor 120 may obtain one from among the first modality and the third modality, and obtain the other one from among the first modality and the third modality when a portion of the obtained modality is identified as corrupted or identified as requiring restoration.

The processor 120 may identify information corresponding to the first type and the second type from among the cross-modality dependency information based on the application in execution in the electronic apparatus 100. For example, the electronic apparatus 100 may further include a communication interface and a display, and the processor 120 may obtain, based on a video call application being executed, the first modality of the voice type from among the plurality of modality types from the another electronic apparatus through the communication interface, identify the video type as the second type based on the video call application, identify information corresponding to the voice type and the video type from among the cross-modality dependency information, obtain the second modality of the video type by inputting the first modality and the identified information in the neural network model, and display a screen corresponding to the second modality through the display. That is, the processor 120 may provide, based on only voice data being received without video data from another electronic apparatus which is a subject of the video call application, the video call function without having to receive video data according to generating a video from the voice.

The processor 120 may update the second modality based on a state of a communication channel with another electronic apparatus, and display a screen corresponding to the updated second modality through the display. Accordingly, the processor 120 may provide the screen corresponding to the second modality which reflects the state of the communication channel. The processor 120 may update the first modality based on the state of the communication channel with the another electronic apparatus, obtain the second modality of the video type by inputting the updated first modality and the identified information in the neural network model, and display the screen corresponding to the second modality through the display.

However, the disclosure is not limited thereto, and the processor 120 may perform an operation for obtaining the second modality of the video type even if the first modality of the voice type and the second modality of the video type are received from the another electronic apparatus through the communication interface due to the video call application being executed. For example, the processor 120 may obtain the second modality of the video type from the first modality of the voice type based on at least one from among the state of the communication channel with the another electronic apparatus or a performance of the another electronic apparatus, and display the screen corresponding to the second modality through the display. In this case, the processor 120 may request to stop the transmission of the second modality of the video type to the another electronic apparatus.

The electronic apparatus 100 may further include the microphone and the communication interface (e.g., including communication circuitry), and the processor 120 may obtain, based on the video call application being executed, the first modality of the voice type from among the plurality of modality types through the microphone, identify information corresponding to the voice type and the video type from among the cross-modality dependency information based on the video call application, obtain the second modality of the video type by inputting the first modality and the identified information in the neural network model, and control the communication interface to transmit the second modality to the another electronic apparatus.

For example, the processor 120 may obtain, based on the electronic apparatus 100 not including the camera, the first modality of the voice type through the microphone, obtain the second modality of the video type from the first modality, and control the communication interface to transmit the second modality to the another electronic apparatus.

The processor 120 may obtain the first modality of the first type and the third modality of a third type from among the plurality of modality types, identify information corresponding to the first type and the third type from among the cross-modality dependency information, and verify the other one from among the first modality and the third modality based on information obtained by inputting one from among the first modality and the third modality and the identified information in the neural network model. In an example, the processor 120 may identify whether a face of another user of another electronic apparatus and a voice of another user correspond during a video call.

The processor 120 may update the second modality based on a state of health of the user corresponding to the first modality. For example, the cross-modality dependency information may be generated when the state of health of the user is good, but may have to correct the same if the state of health of the user deteriorates thereafter, and the processor 120 may obtain the second modality reflected with the state of health of the user by updating the second modality based on the state of health of the user corresponding to the first modality. The processor 120 may update the first modality based on the state of health of the user, and obtain the second modality based on the updated first modality.

The processor 120 may obtain the first modality of the first type from among the plurality of modality types, encode the first modality, identify the second type based on context, identify information corresponding to the first type and the second type from among the cross-modality dependency information, obtain output data by inputting the encoded first modality and the identified information in the neural network model, and obtain the second modality by decoding the output data.

Although obtaining the other one modality from one modality has been described, the disclosure is not limited thereto. For example, the processor 120 may obtain a target modality from the modalities of at least two types.

A function associated with artificial intelligence according to the disclosure may be operated through the processor 120 and the memory 110.

The processor 120 may be configured with one or a plurality of processors. The one or plurality of processors may be a generic-purpose processor such as the CPU, an application processor (AP), a digital signal processor (DSP), and the like, a graphics dedicated processor such as the GPU and a vision processing unit (VPU), and/or an artificial intelligence dedicated processor such as the NPU.

The one or plurality of processors may control the input data to be processed according to a pre-defined (e.g., specified) operation rule or the artificial intelligence model stored in the memory 110. If the one or plurality of processors is an artificial intelligence dedicated processor, the artificial intelligence dedicated processor may be designed to a hardware structure specializing in the processing of a specific artificial intelligence model. The pre-defined operation rule or the artificial intelligence model may be characterized by being created through learning.

The being created through learning referred herein may refer, for example, to the pre-defined operation rule or artificial intelligence model set to perform a desired feature (or, purpose) being created as a basic artificial intelligence model is trained by a learning algorithm using a plurality of training data. The training may be carried out in a device itself in which the artificial intelligence according to the disclosure is performed, or carried out through a separate server and/or system. Examples of the learning algorithm may include a supervised learning, a unsupervised learning, a semi-supervised learning, or a reinforcement learning, but is not limited to the above-described examples.

The artificial intelligence model may be configured with a plurality of neural network layers. Each of the neural network layers may include a plurality of weight values, and perform a neural network operation through operations between an operation result of a previous layer and the plurality of weight values. The plurality of weight values included in the plurality of neural network layers may be optimized by a learning result of the artificial intelligence model. For example, the plurality of weight values may be updated for a loss value or a cost value obtained in the artificial intelligence model during the training process to be reduced or minimized.

The artificial neural network may include a Deep Neural Network (DNN), and examples thereof may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Generative Adversarial Network (GAN), Deep-Q Networks, or the like, but is not limited thereto.

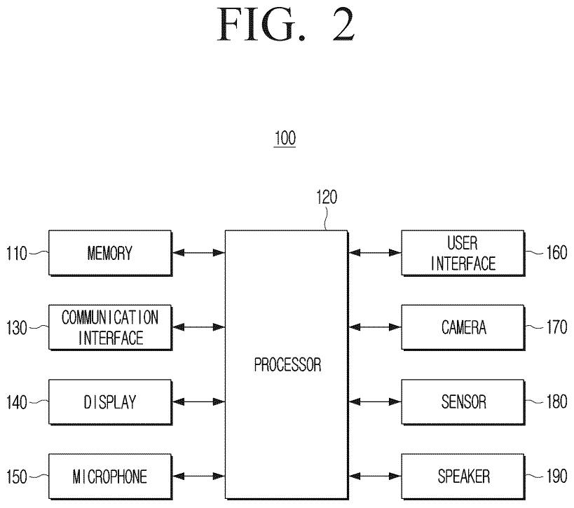

FIG. 2 is a block diagram illustrating an example configuration of the electronic apparatus 100 according to various embodiments. The electronic apparatus 100 may include the memory 110 and the processor (e.g., including processing circuitry) 120. Referring to FIG. 2, the electronic apparatus 100 may further include a communication interface (e.g., including communication circuitry) 130, a display 140, a microphone 150, a user interface (e.g., including circuitry) 160, a camera 170, a sensor 180, and a speaker 190. Detailed descriptions for parts that overlap with the elements shown in FIG. 1 from among the elements shown in FIG. 2 may not be repeated here.

The communication interface 130 may include various communication circuitry and be a configuration for performing communication with external apparatuses of various types according communication methods of various types. For example, the electronic apparatus 100 may perform communication with another electronic apparatus through the communication interface 130.

The communication module 130 may include a WiFi module, a Bluetooth module, an infrared communication module, a wireless communication module, and the like. Here, each communication module may be implemented in at least one hardware chip form.

The WiFi module and the Bluetooth module may perform communication in a WiFi method and a Bluetooth method, respectively. When using the WiFi module or the Bluetooth module, various connection information such as a service set identifier (SSID) and a session key may first be transmitted and received, and may transmit and receive various information after communicatively connecting using the same. The infrared communication module may perform communication according to an infrared communication (Infrared Data Association (IrDA)) technology of transmitting data wirelessly in short range using infrared rays present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

The communication interface 130 may include a wired communication interface such as, for example, and without limitation, HDMI, DP, Thunderbolt, USB, RGB, D-SUB, DVI, and the like.

The communication interface 130 may include at least one from among wired communication modules that perform communication using a local area network (LAN) module, an Ethernet module, or a pair cable, a coaxial cable or an optical fiber cable, or the like.

The display 140 may be a configuration that displays an image, and implemented as displays of various forms such as, for example, and without limitation, a liquid crystal display (LCD), an organic light emitting diode (OLED) display, a plasma display panel (PDP), or the like. In the display 140, a driving circuit, which may be implemented in a form of an a-si TFT, a low temperature poly silicon (LTPS) TFT, an organic TFT (OTFT), or the like, a backlight unit, and the like may be included. The display 140 may be implemented as a touch screen coupled with a touch sensor, a flexible display, a three-dimensional display (3D display), or the like.

The microphone 150 may be a configuration for receiving sound and converting to an audio signal. The microphone 150 may be electrically connected with the processor 120, and may receive sound by control of the processor 120.

For example, the microphone 150 may be formed as an integrated-type integrated to an upper side or a front surface direction, a side surface direction or the like of the electronic apparatus 100. The microphone 150 may be provided in a remote controller, or the like separate from the electronic apparatus 100. In this case, the remote controller may receive sound through the microphone 150, and provide the received sound to the electronic apparatus 100.

The microphone 150 may include various configurations such as a microphone that collects sound in an analog form, an amplifier circuit that amplifies the collected sound, an A/D converter circuit that samples the amplified sound and converts to a digital signal, a filter circuit that removes noise components from the converted digital signal, and the like.

The microphone 150 may be implemented in a form of a sound sensor, and may be any method so long as it is a configuration that can collect sound.

The user interface 160 may include various circuitry and be implemented as a button, a touch pad, a mouse, a keyboard, and the like, or implemented as a touch screen capable of performing a display function and an operation input function together therewith. The button may be buttons of various types such as a mechanical button, a touch pad, or a wheel which is formed at a random area at a front surface part or a side surface part, a rear surface part, or the like of an exterior of a main body of the electronic apparatus 100.

The camera 170 may be a configuration for capturing a still image or a moving image. The camera 170 may capture the still image at a specific time point, but may also capture the still image consecutively.

The camera 170 may include a lens, a shutter, an aperture, a solid-state imaging device, an Analog Front End (AFE), and a Timing Generator (TG). The shutter may adjust time during which light reflected from a subject enters the camera 170, and the aperture may adjust an amount of light incident to the lens by mechanically increasing or decreasing a size of an opening part through which light enters. The solid-state imaging device may output, based on light reflected from the subject being accumulated as photo charge, an image by the photo charge as an electric signal. The TG may output a timing signal for reading out pixel data of the solid-state imaging device, and the AFE may digitalize the electric signal output from the solid-state imaging device by sampling.

The sensor 180 may include various circuitry and be a configuration for obtaining biometric information associated with the user of the electronic apparatus 100, and may include a temperature sensor, a PhotoPlethysmoGraphy (PPG) sensor, and the like.

The temperature sensor may be a sensor that measures temperature of body or component. The temperature sensor may be implemented as a contact-type or a noncontact-type, and a measured temperature value may be provided to the memory 110 or the processor 120. The processor 120 may correct skin temperature or body temperature or identify a situation based on the measured temperature value of the temperature sensor.

The PPG sensor may be a sensor for measuring changes in blood flow rate in veins near the skin. The processor 120 may obtain respiration information of the user based on the PPG sensor. The user may experience a faster heartbeat while inhaling, and experience a slower heartbeat while exhaling, and the processor 120 may obtain respiration information from data obtained from the PPG sensor based on a relationship known as respiratory sinus arrhythmia between the breathing described above and heart rate.

The sensor 180 may include a configuration for obtaining orientation information of the electronic apparatus 100. For example, the sensor 180 may further include at least one from among a gyro sensor, an acceleration sensor, or a magnetic field sensor. The processor 120 may obtain motion information of the user based on the orientation information of the electronic apparatus 100 obtained through the sensor 180.

The gyro sensor may be a sensor for detecting a rotation angle of the electronic apparatus 100, and may measure a change in orientation of an object using a property of always maintaining a certain direction that was initially set with high accuracy regardless of a rotation of the Earth. The gyro sensor may be referred to as a Gyroscope, and may be implemented in a mechanical manner or an optical manner using light.

The gyro sensor may measure angular velocity. An angular velocity may refer, for example, to an angle of rotation per hour, and a measuring principle of the gyro sensor is as described below. For example, the angular velocity in a horizontal state (stationary state) may be 0 degrees/sec, and then, if an object is tiled by 50 degrees while moving for 10 seconds, an average angular velocity for 10 seconds may be 5 degrees/sec. If the angle of 50 degrees titled in the stationary state was maintained, the angular velocity may be 0 degrees/sec. Through the process described above, the angular velocity was changed from 0→5→0, and the angle was increased from 0 degrees to 50 degrees. In order to obtain an angle from the angular velocity, integration has to be carried out for the whole time. Because the gyro sensor measures the angular velocity as described above, the tilted angle may be calculated by integrating the angular velocity for the whole time. However, an error may occur in the gyro sensor due to effect of temperature, and a final value may be drifted due to errors being accumulated in an integration process. Accordingly, the electronic apparatus 100 may further include the temperature sensor, and the error of the gyro sensor may be compensated using the temperature sensor.

The acceleration sensor may be a sensor for measuring acceleration or intensity of impact of the electronic apparatus 100, and may be referred to as an accelerometer. The acceleration sensor may sense dynamic force such as, for example, and without limitation, acceleration, vibration, impact, and the like and may be implemented as an inertial-type, a gyro-type, a silicon semiconductor-type, and the like according to a detection method. That is, the acceleration sensor may be a sensor that senses a degree to which the electronic apparatus 100 is tilted using gravitational acceleration, and may be generally formed as a 2-axis or 3-axis fluxgate.

The magnetic field sensor may generally refer to a sensor that measures a strength and direction of magnetism of the Earth, but in a broader sense, include a sensor that measures a strength of magnetization of an object, and may be referred to as a magnetometer. The magnetic field sensor may be implemented to measure a direction to which a magnet moves by hanging a magnet horizontally in a magnetic field, or measures a strength of the magnetic field by rotating a coil in the magnetic field and measuring an induced electromotive force that is generated in the coils.

A geomagnetic sensor which is a type of the magnetic field sensor that measures the strength of magnetism of the Earth may be implemented as a fluxgate-type geomagnetic sensor which generally detects geomagnetism using fluxgate. The fluxgate-type geomagnetic sensor uses high permeability materials such as permalloy as a magnetic core, and may refer, for example, to an apparatus that measures size and direction of an external magnetic field by measuring magnetic saturation of the magnetic core by applying excitation magnetic field through coil that winds the magnetic core and a second harmonic component proportional to the external magnetic field generated according to a nonlinear magnetic characteristics. A current azimuth may be detected by measuring the size and direction of the external magnetic field, a degree of rotation may be measured according thereto. The geomagnetic sensor may be formed as the 2-axis or 3-axis fluxgate. A 2-axis fluxgate sensor, that is, a 2-axis sensor may refer to a sensor formed with an x-axis fluxgate and a y-axis fluxgate that are orthogonal to each other, and a 3-axis fluxgate sensor, that is, a 3-axis sensor may refer to a sensor added with a z-axis fluxgate to the x-axis and y-axis fluxgates.

When the geomagnetic sensor and the acceleration sensor as described above are used, orientation information of the electronic apparatus 100 may be obtained. For example, the orientation information of the electronic apparatus 100 may be expressed as a pitch angle, a roll angle, or an azimuth.

The azimuth (a yaw angle) may refer, for example, to an angle that changes direction left and right on a horizontal surface, and when the azimuth is calculated, to which direction the electronic apparatus 100 is facing may be identified. For example, the azimuth may be calculated through an Equation as shown below when using the geomagnetic sensor.

$$ψ = arctan ( sin ψ / cos ψ )$$

Here, ψ may refer to the azimuth, and cosψ and sinψ may refer to output values of the x-axis and y-axis fluxgates.

The roll angle may refer to an angle to which the horizontal surface is tilted laterally, and when the roll angle is calculated, a left or right gradient of the electronic apparatus 100 may be identified. The pitch angle may refer to an angle to which the horizontal surface is tilted vertically, and when the pitch angle is calculated, the gradient angle to which the electronic apparatus 100 is tilted toward an upper side or a lower side may be identified. For example, when using the acceleration sensor, the roll angle and the pitch angle may be measured through Equations below.

$$φ = arcsin ( ay / g )$$

$$θ = arcsin ( ax / g )$$

Here, g may indicate the gravitational acceleration, φ may indicate the roll angle, θ may indicate the pitch angle, ax may indicate an x-axis acceleration sensor output value, and ay may indicate a y-axis acceleration sensor output value.

In the above, for convenience of description, the sensor 180 has been described as including at least one from among the gyro sensor, the acceleration sensor, the magnetic field sensor, or the sound sensor. However, the disclosure is not limited thereto, and the sensor 180 may be any sensor so long as it is a sensor capable of obtaining the orientation information of the electronic apparatus 100. The processor 120 may sense a motion of the user based on the orientation information of the electronic apparatus 100.

The speaker 190 may be an element that outputs not only various audio data processed in the processor 120, but also various notification sounds, voice messages, or the like.

As described above, because the electronic apparatus 100 can obtain not only the modality but also the target modality by further using the cross-modality dependency information, a modality processing load may be reduced while improving performance.

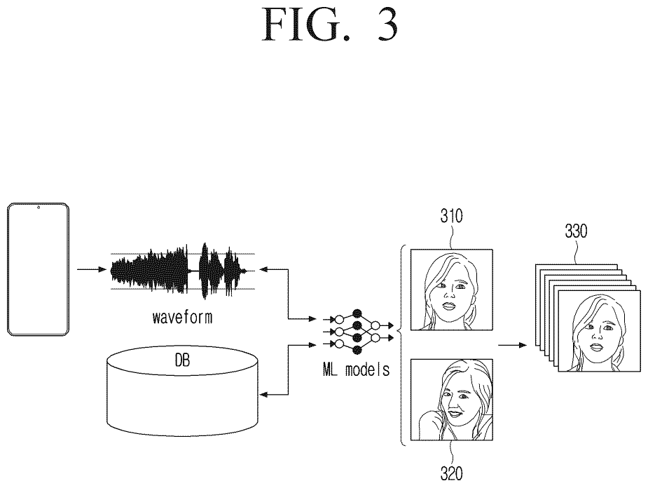

An operation of the electronic apparatus 100 will be described in greater detail below with reference to FIG. 3 to FIG. 13. In FIG. 3 to FIG. 13, individual embodiments will be described for convenience of description. However, the individual embodiments of FIG. 3 to FIG. 13 may be implemented in any combined state.

FIG. 3 is a diagram illustrating an example neural network model according to various embodiments.

The processor 120 may obtain the first modality of the first type. For example, as shown in FIG. 3, if the electronic apparatus is a smartphone, the processor 120 may obtain the voice (waveform) of the user through the microphone 150 provided in the electronic apparatus 100 as the first modality of the first type.

The processor 120 may identify the second type from among the plurality of modality types based on the context. For example, the processor 120 may identify, based on the video call application being executed, a video from among the plurality of modality types as the second type. The processor 120 may identify information corresponding to a video which is the first type and a video which is the second type from among the cross-modality dependency information (DB), and obtain a second modality 310 of the video type by inputting the voice of the user and the identified information in the neural network model (ML models).

The processor 120 may obtain the second modality 310 of the video type and a video stream 330 based on an actual facial image 320 of a person included in the second modality 310 of the video type.

The processor 120 has been described as identifying the second type from among the plurality of modality types based on the context. The context may be included with information about the first modality of the first type currently secured by the processor 120. For example, the processor 120 may identify, based on the first modality of the first type being secured, one from among a plurality of types that form a pair with the first type as the second type. In an example, if the first type is a voice, and the cross-modality dependency information includes voice-video dependency information and voice-fingerprint dependency information, the processor 120 may not be able to identify the heart rate or the bioacoustic signal as the second type, but may be able to identify the video or the fingerprint as the second type.

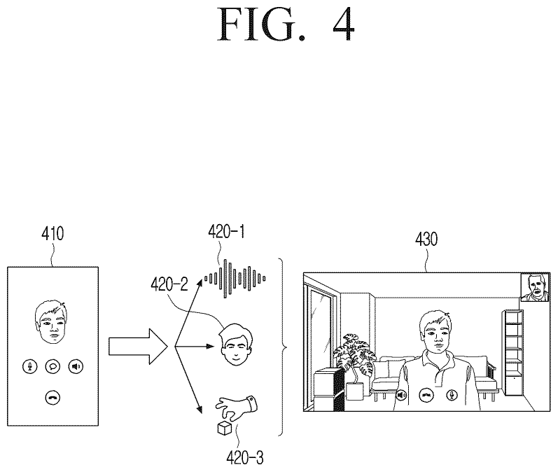

FIG. 4 is a diagram illustrating an example operation according to an incomplete modality according to various embodiments.

The processor 120 may obtain the first modality of the first type from among the plurality of modality types. For example, the processor 120 may obtain, when the video call application is executed, a first modality 410 of the video type as shown in FIG. 4.

The processor 120 may identify that there is an error in the first modality 410 of the video type. For example, the processor 120 may identify that there is an error in the first modality 410 of the video type based on resolution, capacity, and the like of the first modality 410 of the video type.

The processor 120 may identify, based on it being identified that there is an error in the first modality 410 of the video type, the second modality of a different obtainable type. For example, the processor 120 may identify a voice type 420-1, a video type 420-2, a minute motion 420-3, and the like as the second modality of the different obtainable type.

The processor 120 may identify information corresponding to the video type and the different obtainable type from among the plurality of modality types, and re-obtain a first modality 430 of the video type by inputting the second modality and the identified information in the neural network model.

The processor 120 may provide the re-obtained first modality 430 of the video type to the user. Alternatively, the processor 120 may remove an error in an initially obtained first modality 410 of the video type based on the re-obtained first modality 430 of the video type, and provide the error-removed first modality 410 of the video type.

Through the operation described above, a modality that is incomplete or in which an error occurred may be corrected.

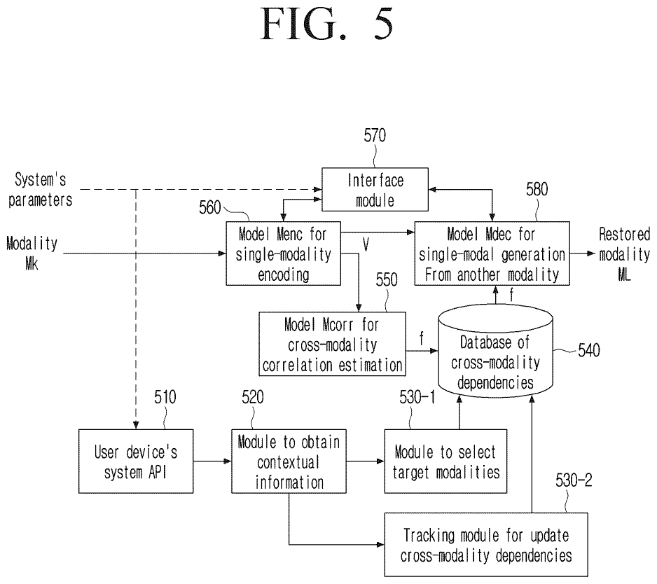

FIG. 5 is a diagram illustrating an example method for processing modality according to various embodiments.

The processor 120 may obtain system's parameters through a system API 510 of the electronic apparatus 100.

The processor 120 may identify the context through a context identifying module 520, and identify the second type corresponding to the context through a target modality selecting module 530-1. In addition, the processor 120 may obtain update information through a tracking module 530-2 for updating the cross-modality dependency information, and update the cross-modality dependency information 540.

The processor 120 may obtain a first modality (Mk) of the first type from among the plurality of modality types, and obtain an encoded first modality (V) by encoding the first modality (Mk) through an encoding model (Menc) 560. The first modality (Mk) described above may be obtained from the system's parameters through an interface module 570.

The processor 120 may identify a type corresponding to the encoded first modality (V) through a correlation model (Mcorr) 550, and identify information corresponding to an identification result (f) from among the cross-modality dependency information.

The processor 120 may obtain a second modality (ML) of the second type based on the identified information from among the first modality (Mk) and the cross-modality dependency information through a modality generating model (Mdec) 580.

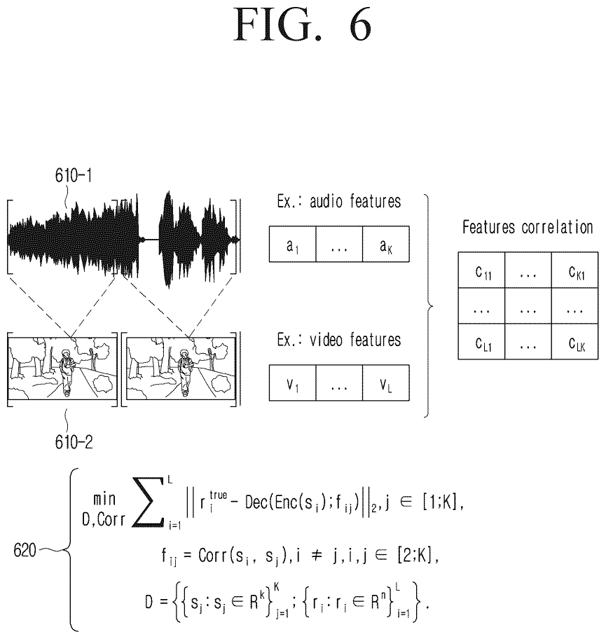

FIG. 6 is a diagram illustrating example cross-modality dependency information and a training method of a neural network model according to various embodiments.

The processor 120 may update, based on a modality of the plurality of types being obtained, the cross-modality dependency information based on the modality of the plurality of types.

For example, the processor 120 may obtain, based on a voice 610-1 and a video 610-2 being obtained as shown at an upper end of FIG. 6, an audio feature and a video feature from each of the voice 610-1 and the video 610-2, and obtain information (feature correlation) about a correlation between the modalities based on the audio feature and the video feature. The processor 120 may add or update the information about the correlation between the modalities in the cross-modality dependency information.

The voice 610-1 and the video 610-2 may be modalities obtained during the same time interval.

The processor 120 may train the encoding model (Menc), the correlation model (Mcorr), and the modality generating model (Mdec) of FIG. 5 for an Equation 620 as in the lower end of FIG. 6 to be minimized. For example, the neural network model may be implemented in a form including the encoding model (Menc), the correlation model (Mcorr), and the modality generating model (Mdec). However, the disclosure is not limited thereto, and the neural network model may be implemented in any various form.

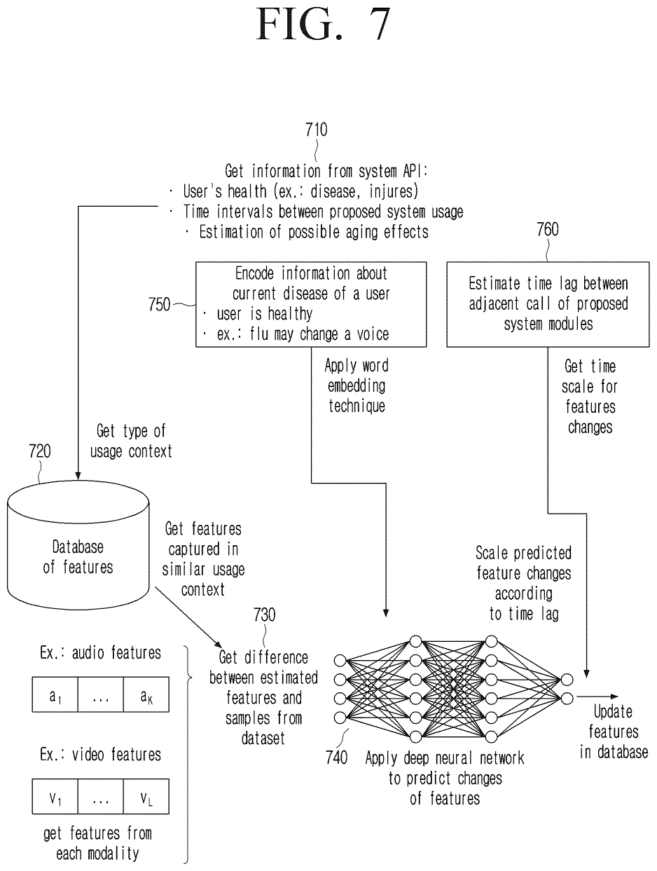

FIG. 7 is a diagram illustrating an example neural network operation according to various embodiments.

The processor 120 may obtain, as shown in FIG. 7, various information 710 from the system API. For example, the processor 120 may obtain information about a state of health of the user from the system API, a state of use of the electronic apparatus 100, and the like. In addition, the processor 120 may obtain the first modality of the first type from among the plurality of modality types.

The processor 120 may identify the second type from among the plurality of modality types based on the context, and identify information corresponding to the first type and the second type from among cross-modality dependency information 720. For example, the processor 120 may obtain, as shown in FIG. 7, audio features and video features, and obtain difference 730 between the features.

The processor 120 may obtain the second modality of the second type by inputting the first modality and the difference between the features in a neural network model 740.

The processor 120 may encode the state of health of the user, and the like, and input the encoded information 750 in a neural network operation, or estimate a time lag 760 and input the time lag 760 in the neural network operation.

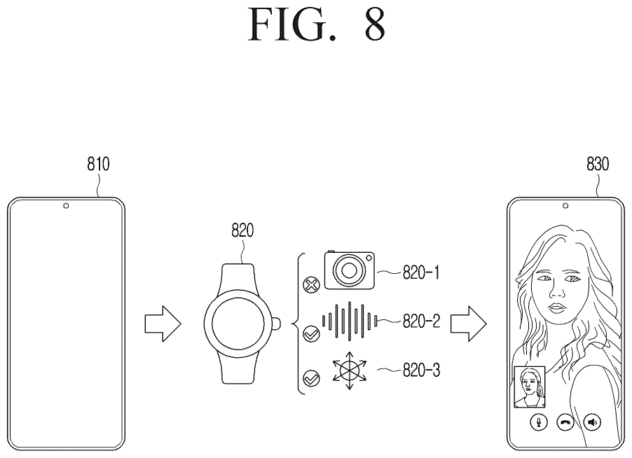

FIG. 8 is a diagram illustrating an example operation due to a difference in specification between apparatuses according to various embodiments.

A smartphone 810 may perform a video call with a smart watch 820. At this time, the smart watch 820 may obtain a voice 820-2 through the microphone, and may be in a state capable of obtaining a minute motion 820-3 of the user through the sensor, or incapable of obtaining a video 820-1 for not including the camera.

The smartphone 810 may receive at least one from among the voice 820-2 or the minute motion 820-3 from the smart watch 820. The smartphone 810 may identify, while performing a video call, a video as necessary based on the context of only at least one of the voice 820-2 or the minute motion 820-3 being received from the smart watch 820.

The smartphone 810 may identify information corresponding to a type and video of modality received from the smart watch 820 from among the cross-modality dependency information, and obtain a modality 830 of the video type by inputting the modality received from the smart watch 820 and the identified information in the neural network model.

The smartphone 810 may provide the modality 830 of the video type.

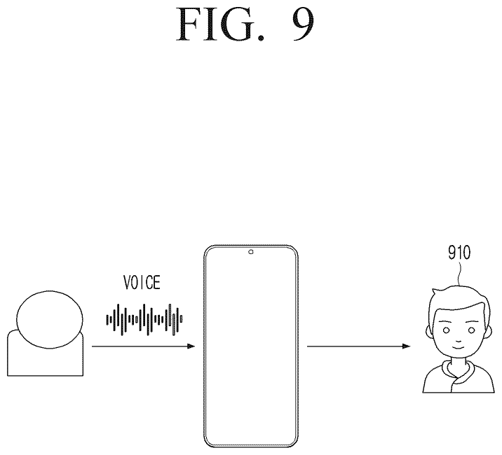

FIG. 9 is a diagram illustrating an example method for providing an emoji according to various embodiments.

The processor 120 may obtain the first modality of the voice type from among the plurality of modality types, identify an emoji type as the second type based on a user command, identify information corresponding to the first type and the second type from among the cross-modality dependency information, and obtain a second modality 910 of the emoji type by inputting the first modality and the identified information in the neural network model. An emoji may be a special character with which an emotion can be expressed in a character basis since an illustration represents a single character on its own.

For example, the processor 120 may add not only information about a correlation between the modality of the voice type of the user and the modality of the video type of the user, but also information about a correlation between the modality of the voice type of the user and the modality of the emoji type to the cross-modality dependency information. Through the operation described, the electronic apparatus 100 may project personal information of the user.

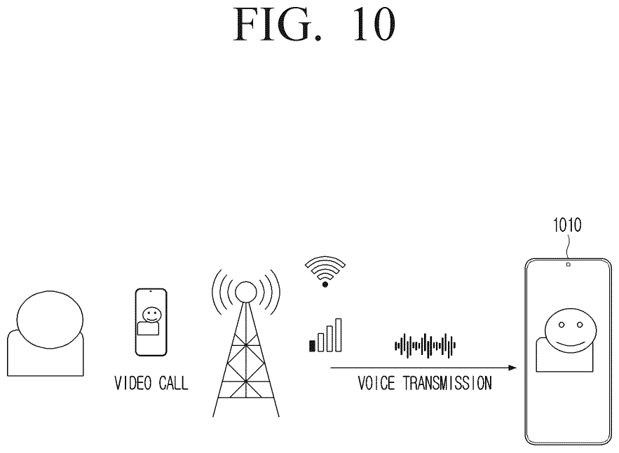

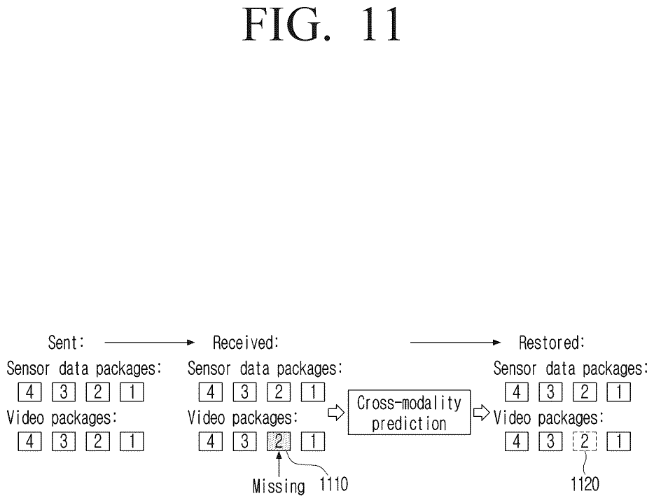

FIG. 10 and FIG. 11 are diagrams illustrating an example operation according to a transmission error according various embodiments.

The electronic apparatus 100 may perform a video call with another electronic apparatus. However, both the video and voice may not be transmitted due to problems in the communication channel, and only the voice may be transmitted.

For example, the processor 120 may perform a video call with another electronic apparatus as shown in FIG. 10, and receive a video and a voice. The processor 120 may update the cross-modality dependency information based on information about the correlation between the video and the voice.

Then, the processor 120 may identify, based on only the voice being received from the another electronic apparatus for problems in the communication channel, information corresponding to the voice and the video from among the cross-modality dependency information, and obtain a modality 1010 of the video type by inputting the voice and the identified information in the neural network model.

The processor 120 may receive, as shown in FIG. 11, sensor data and video data. The processor 120 may identify, based on omitted data 1110 from among the video data being identified, information corresponding to the sensor data and the video data from among the cross-modality dependency information, and restore video data 1120 by inputting the sensor data and the identified information in the neural network model.

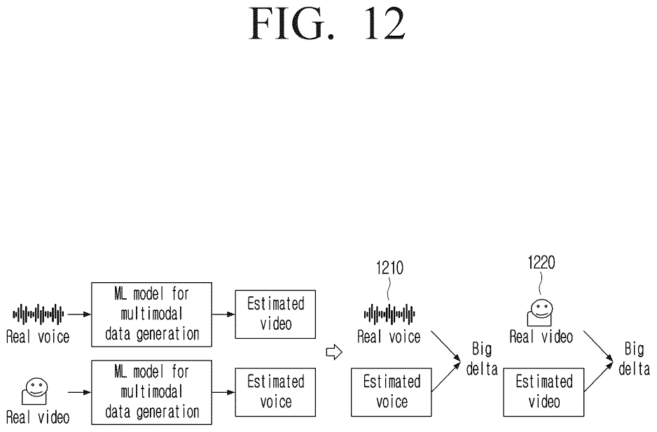

FIG. 12 is a diagram illustrating an example verification operation between modalities according to various embodiments.

The processor 120 may obtain a first modality (real voice) of the voice type and a first modality (real video) of the video type as shown in FIG. 12.

The processor 120 may identify information corresponding to the voice and the video from among the cross-modality dependency information, and obtain a second modality (estimated video) of the video type by inputting the first modality (real voice) of the voice type and the identified information in the neural network model. In addition, the processor 120 may identify information corresponding to the voice and the video from among the cross-modality dependency information, and obtain a second modality (estimated voice) of the voice type by inputting the first modality (real video) of the video type and the identified information in the neural network model.

The processor 120 may compare a first modality (real voice) 1210 of the voice type and the second modality (estimated voice) of the voice type obtained through the neural network model, and compare a first modality (real video) 1220 of the video type and the second modality (estimated video) of the video type obtained through the neural network model.

The processor 120 may detect whether there is modulation through the comparison results. Through the operation described, fraud (or scamming) by deep fakes and the like may be prevented and/or reduced.

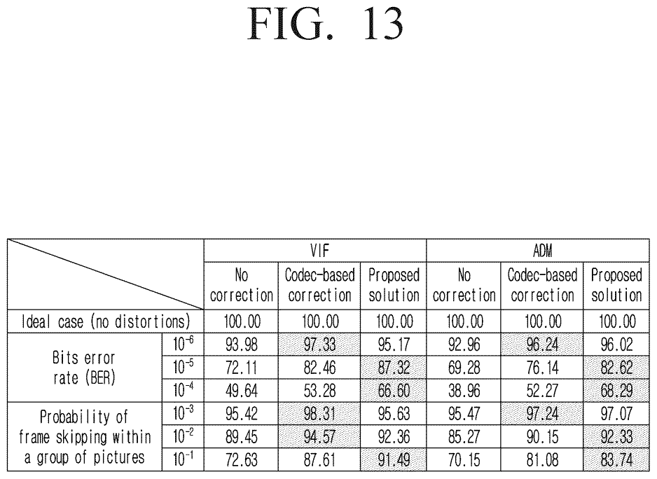

FIG. 13 is a diagram illustrating an example effect according to various embodiments.

As shown in FIG. 13, a bit error rate and a frame skipping possibility may be reduced through the various example operations described in the disclosure.

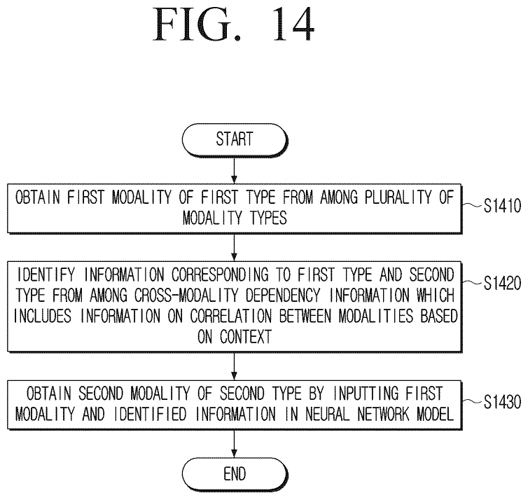

FIG. 14 is a flowchart illustrating an example method operating or controlling an electronic apparatus according to various embodiments.

The first modality of the first type from among the plurality of modality types may be obtained (S1410). Information corresponding to the first type and the second type from among the cross-modality dependency information which includes information on the correlation between modalities may be identified based on the context (S1420). The second modality of the second type may be obtained by inputting the first modality and the identified information in the neural network model (S1430).

The obtaining the first modality (S1410) may include obtaining the first modality of the first type and the third modality of the second type from among the plurality of modality types, the identifying (S1420) may include identifying, based on a portion of the third modality being identified as damaged or identified as requiring restoration, information corresponding to the first type and the second type from among the cross-modality dependency information, and the obtaining the second modality (S1430) may include obtaining the second modality of the second type corresponding to the third modality by inputting the first modality and the identified information in the neural network model, and the control method may further include restoring a portion of the third modality based on the second modality.

The identifying (S1420) may include identifying information corresponding to the first type and the second type from among the cross-modality dependency information based on an application in execution in the electronic apparatus.

The obtaining the first modality (S1410) may include obtaining, based on a video call application being executed, the first modality of the voice type from among the plurality of modality types from another electronic apparatus, the identifying (S1420) may include identifying information corresponding to the voice type and the video type from among the cross-modality dependency information based on the video call application, and the obtaining the second modality (S1430) may include obtaining the second modality of the video type by inputting the first modality and the identified information in the neural network model, and the control method may further include displaying a screen corresponding to the second modality.

Updating the second modality based on a state of the communication channel with the another electronic apparatus may be further included, and the displaying may include displaying a screen corresponding to the updated second modality.

The obtaining the first modality (S1410) may include obtaining, based on the video call application being executed, the first modality of the voice type from among the plurality of modality types through the microphone included in the electronic apparatus, the identifying (S1420) may include identifying information corresponding to the voice type and the video type from among the cross-modality dependency information based on the video call application, and the obtaining the second modality (S1430) may include obtaining the second modality of the video type by inputting the first modality and the identified information in the neural network model, and the control method may further include transmitting the second modality to the another electronic apparatus.

The obtaining the first modality (S1410) may include obtaining the first modality of the first type and the third modality of the third type from among the another electronic apparatus, and the control method may further include identifying information corresponding to the first type and the third type from among the cross-modality dependency information and verifying the other one from among the first modality and the third modality based on information obtained by inputting one from among the first modality and the third modality and the identified information in the neural network model.

Updating the second modality based on the state of health of the user corresponding to the first modality may be further included.

The method may further include encoding the first modality, and the obtaining the second modality (S1430) may include obtaining an output data by inputting the encoded first modality and the identified information in the neural network model, and obtaining the second modality by decoding the output data.

The cross-modality dependency information may be obtained based on sample modalities of at least two types from among the plurality of modality types.

According to various embodiments of the disclosure as described above, because the electronic apparatus can obtain not only the modality but also the target modality by further using the cross-modality dependency information, a modality processing load may be reduced while performance is improved.

According to various embodiments of the disclosure, the various embodiments described above may be implemented with software including instructions stored in a machine-readable storage media (e.g., computer). The machine may call an instruction stored in a storage medium, and as an apparatus operable according to the called instruction, may include an electronic apparatus (e.g., electronic apparatus (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, a ‘non-transitory’ storage medium is tangible and may not include a signal, and the term does not differentiate data being semi-permanently stored or being temporarily stored in the storage medium.

According to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

According to an embodiment of the disclosure, the various embodiments described above may be implemented in a recordable medium which is readable by a computer or an apparatus similar to the computer using software, hardware, or the combination of software and hardware. In some cases, the various embodiments described herein may be implemented by the processor itself. According to a software implementation, embodiments such as the procedures and functions described herein may be implemented as a separate software. The respective software may perform one or more functions and operations described herein.

Computer instructions for performing processing operations of an apparatus according to the various embodiments described above may be stored in a non-transitory computer-readable medium. The computer instructions stored in this non-transitory computer-readable medium may cause a specific device to perform a processing operation in an apparatus according to the above-described various embodiments when executed by a processor of a specific apparatus. The non-transitory computer-readable medium may refer to a medium that stores data semi-permanently and is readable by an apparatus. Specific examples of the non-transitory computer-readable medium may include, for example, and without limitation, a compact disc (CD), a digital versatile disc (DVD), a hard disc, a Blu-ray disc, a USB, a memory card, a ROM, and the like.

Each of the elements (e.g., a module or a program) according to various embodiments described above may be configured as a single entity or a plurality of entities, and a portion of sub elements from among the above-described relevant sub-elements may be omitted, or other sub-elements may be further included in the various embodiments. Alternatively or additionally, a portion of the elements (e.g., modules or programs) may be integrated into one entity to perform the same or similar functions performed by each of the relevant elements prior to integration. Operations performed by a module, a program, or other element, in accordance with the various embodiments, may be executed sequentially, in parallel, repetitively, or in a heuristically manner, or at least a portion of the operations may be performed in a different order, omitted, or a different operation may be added.

While the disclosure has been illustrated and described with reference to example embodiments thereof, it will be understood that the various embodiments are intended to be illustrative, not limiting. It will be understood by those skilled in the art that various changes in form and detail may be made therein without departing from the true spirit and full scope of the disclosure, including the appended claims and their equivalents. It will also be understood than any of the embodiment(s) described herein may be used in conjunction with any other embodiment(s) described herein.

What is claimed is:

1. An electronic apparatus, comprising:
a memory storing cross-modality dependency information comprising information on a correlation between modalities, a neural network model, and instructions; and
at least one processor comprising processing circuitry,
wherein at least one processor, individually or collectively, is configured to execute the instructions and to cause the electronic apparatus to:
obtain a first modality of a first type from among a plurality of modality types,
identify information corresponding to the first type and a second type from among the cross-modality dependency information based on context, and
obtain a second modality of the second type by inputting the first modality and the identified information in the neural network model.

2. The electronic apparatus of claim 1, wherein
at least one processor, individually or collectively, is configured to cause the electronic apparatus to:
obtain the first modality of the first type and a third modality of the second type from among the plurality of modality types,
identify, based on a portion of the third modality being identified as corrupted or identified as requiring restoration, information corresponding to the first type and the second type from among the cross-modality dependency information,
obtain the second modality of the second type corresponding to the third modality by inputting the first modality and the identified information in the neural network model, and
restore a portion of the third modality based on the second modality.

3. The electronic apparatus of claim 1, wherein
at least one processor, individually or collectively, is configured to cause the electronic apparatus to:
identify information corresponding to the first type and the second type from among the cross-modality dependency information based on an application in execution in the electronic apparatus.

4. The electronic apparatus of claim 3, further comprising:
a communication interface comprising communication circuitry; and
a display,
wherein at least one processor, individually or collectively, is configured to cause the electronic apparatus to:
obtain, based on a video call application being executed, the first modality of a voice type from among the plurality of modality types from another electronic apparatus through the communication interface,
identify information corresponding to the voice type and a video type from among the cross-modality dependency information based on the video call application,
obtain the second modality of the video type by inputting the first modality and the identified information in the neural network model, and
display a screen corresponding to the second modality through the display.

5. The electronic apparatus of claim 4, wherein
at least one processor, individually or collectively, is configured to cause the electronic apparatus to:
update the second modality based on a state of a communication channel with the another electronic apparatus, and
display a screen corresponding to the updated second modality through the display.

6. The electronic apparatus of claim 3, further comprising:
a microphone; and
a communication interface comprising communication circuitry,
wherein at least one processor, individually or collectively, is configured to cause the electronic apparatus to:
obtain, based on a video call application being executed, the first modality of a voice type from among the plurality of modality types through the microphone,
identify information corresponding to the voice type and a video type from among the cross-modality dependency information based on the video call application,
obtain second modality of the video type by inputting the first modality and the identified information in the neural network model, and
control the communication interface to transmit the second modality to the another electronic apparatus.

7. The electronic apparatus of claim 1, wherein
at least one processor individually or collectively, is configured to cause the electronic apparatus to:
obtain the first modality of the first type and a third modality of a third type from among the plurality of modality types,
identify information corresponding to the first type and the third type from among the cross-modality dependency information, and
verify the other one from among the first modality and the third modality based on information obtained by inputting one from among the first modality and the third modality and the identified information in the neural network model.

8. The electronic apparatus of claim 1, wherein
at least one processor, individually or collectively, is configured to cause the electronic apparatus to:
update the second modality based on a state of health of a user corresponding to the first modality.

9. The electronic apparatus of claim 1, wherein
at least one processor individually or collectively, is configured to cause the electronic apparatus to:
obtain the first modality of the first type from among the plurality of modality types,
encode the first modality,
identify information corresponding to the first type and the second type from among the cross-modality dependency information based on the context,
obtain output data by inputting the encoded first modality and the identified information in the neural network model, and
obtain the second modality by decoding the output data.

10. The electronic apparatus of claim 1, wherein
the cross-modality dependency information is obtained based on sample modalities of at least two types from among the plurality of modality types.

11. A method of controlling an electronic apparatus, the method comprising:
obtaining a first modality of a first type from among a plurality of modality types;
identifying information corresponding to the first type and a second type from among cross-modality dependency information which includes information on a correlation between modalities based on context; and
obtaining a second modality of the second type by inputting the first modality and the identified information in a neural network model.

12. The method of claim 11, wherein
the obtaining a first modality comprises obtaining the first modality of the first type and a third modality of the second type from among the plurality of modality types,
the identifying comprises identifying, based on a portion of the third modality being identified as corrupted or identified as requiring restoration, information corresponding to the first type and the second type from among the cross-modality dependency information, and
the obtaining a second modality comprises obtaining the second modality of the second type corresponding to the third modality by inputting the first modality and the identified information in the neural network model, and
the method further comprises:
restoring a portion of the third modality based on the second modality.

13. The method of claim 11, wherein
the identifying comprises identifying information corresponding to the first type and the second type from among the cross-modality dependency information based on an application in execution in the electronic apparatus.

14. The method of claim 13, wherein
the obtaining a first modality comprises obtaining, based on a video call application being executed, the first modality of a voice type from among the plurality of modality types from another electronic apparatus,
the identifying comprises identifying information corresponding to the voice type and a video type from among the cross-modality dependency information based on the video call application, and
the obtaining a second modality comprises obtaining a second modality of the video type by inputting the first modality and the identified information in the neural network model, and
the method further comprises:
displaying a screen corresponding to the second modality.

15. The method of claim 14, further comprising:
updating the second modality based on a state of a communication channel with the another electronic apparatus,
wherein the displaying comprises displaying a screen corresponding to the updated second modality.
